(19) United States
(12) Patent Application Publication
(10) Pub. No.: US 2008/0027821 A1
(43) Pub. Date: Jan. 31, 2008

(54) Method and Apparatus for Promotion and Distribution of Electronically Stored Information

(76) Inventor: Aaron Burton, Webster, NY (US)

Correspondence Address: SHLESINGER & FITZSIMMONS, 183 EAST MAIN STREET, SUITE 1323, ROCHESTER, NY, 14604, US

(21) Appl. No.: 11/766,781

(22) Filed: Jun. 21, 2007

Related U.S. Application Data
(60) Provisional application No. 60/805,344, filed on Jun. 21, 2006.

(51) Int. Cl. G06Q 30/00

(52) U.S. Cl. 705/26

(57) ABSTRACT

Embodiments provide for easy and inexpensive distribution and promotion of electronic files, such as audio files, audio-visual files, text files, and more. Subscribers are provided a subsite of a website implementing the invention and can personalize the subsite with information about themselves, any other individuals contributing to the content they create, and can upload images and/or video files to be displayed on the subsite. Subscribers upload content to be distributed and create stored value cards which they can then print locally on stock purchased from the service provider. The stored value cards include unique respective access codes that can be covered with “scrath-off” stickers applied after printing. Card recipients visit a web site listed on the card, scratch off the coating on the sticker, and enter the access code to download the songs to which the card entitles them. In embodiments, content providers/subscribers can opt to allow additional purchases of content.

### CROSS-REFERENCE TO RELATED APPLICATIONS

None applicable.

### BACKGROUND AND SUMMARY

Embodiments relate to distribution systems for electronically stored information, to methods employed in such systems, and to methods of promotion using such systems. More particularly, embodiments relate to a computer network based information storage and retrieval system allowing users to create web sites and stored value cards for promotional purposes. Embodiments further relate to computer network based systems for stored value card and retail sale of electronically stored information. Embodiments are particularly suited to band promotion and music file distribution, but could be employed for other types of information, such as books, lectures, movies, television, and other information that can be stored electronically.

Current electronic distribution systems exist, particularly for music, movie, and television programs, in which the owner of the system arranges with content owners/creators to offer their content for sale, such as on the internet. Consumers then use an application, such as a web browser or a specialized application, to access the distribution system to search for, purchase, and download the content offered by the owner of the system. However, while some such systems allow independent content creators of podcasts and vidcasts to list their content in the system database, the system favors content creators, such as bands, who are signed onto large labels, networks, and other content owners/distributors. And even in the case of the independent content creators that are listed, the listing is passive and non-specialized. Most, if not all, systems will not deal with independent content creators apart from podcasters and vidcasters, so unsigned bands and the like must promote themselves without help or find a label through which they can be promoted.

For content creators who choose to promote themselves, it can be costly and difficult to do so. For example, in the case of a band, paying for a press of CDs they can take to performances and offer for sale can represent a significant investment. Additionally, carrying the CDs is an added burden since a band already must transport their equipment and instruments. Other content creators often run into similar costly and/or burdensome issues with self-promotion. A new way for such content creators to distribute their content is needed, freeing up the creators from the burden of transporting their content and investing in inventory.

Embodiments offer a promotion and distribution system that caters to independent content creators, helping them promote themselves and allowing distribution of their content through online sales. A web site allows content creators to sign up for the program, upload content, customize their own sub-site within the overarching system site, and create stored value cards that the creators can print locally. The stored value cards can be distributed for free or for sale. For example, a band could offer stored value cards redeemable for one or two songs for free, then offer more for retail sale on their site within the system. Alternatively, content creators can charge for the cards, providing as much or as little content as they would like for such a fee. The stored value card of embodiments carries a unique code associated with which the system keeps track of how much and which content the card represents. Using these cards, content creators can distribute their content without carrying the actual content with them. Thus, a band can take a small container of tens of cards, each representing the equivalent of a full CD of content, and sell the cards rather than carrying and selling CDs. Similarly, an independent film maker can take a number of cards to a screening or a convention or the like, each card representing the equivalent of a copy of a movie, and can sell the cards rather than carrying stacks of DVDs or tapes to sell. Similar scenarios present themselves for other content creators.

### BRIEF DESCRIPTION OF THE DRAWINGS

FIG. 1 shows a landing page of an implementation of embodiments.

FIG. 2 shows a signup page of embodiments.

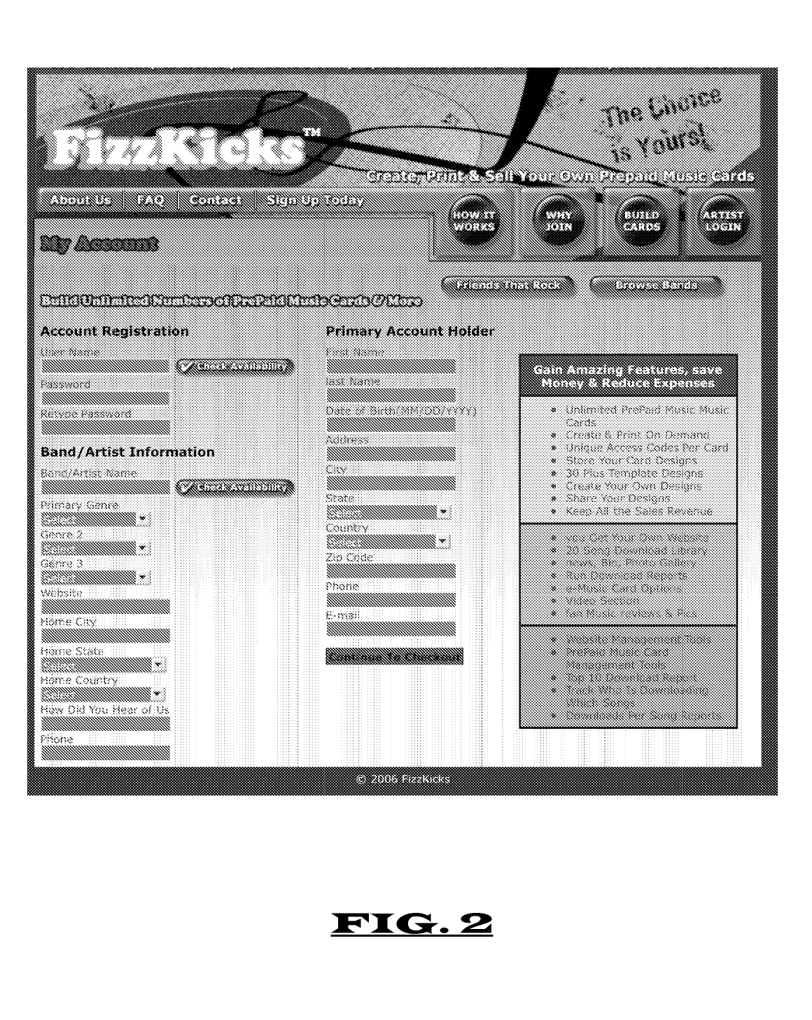

FIG. 3 shows a second signup page of embodiments.

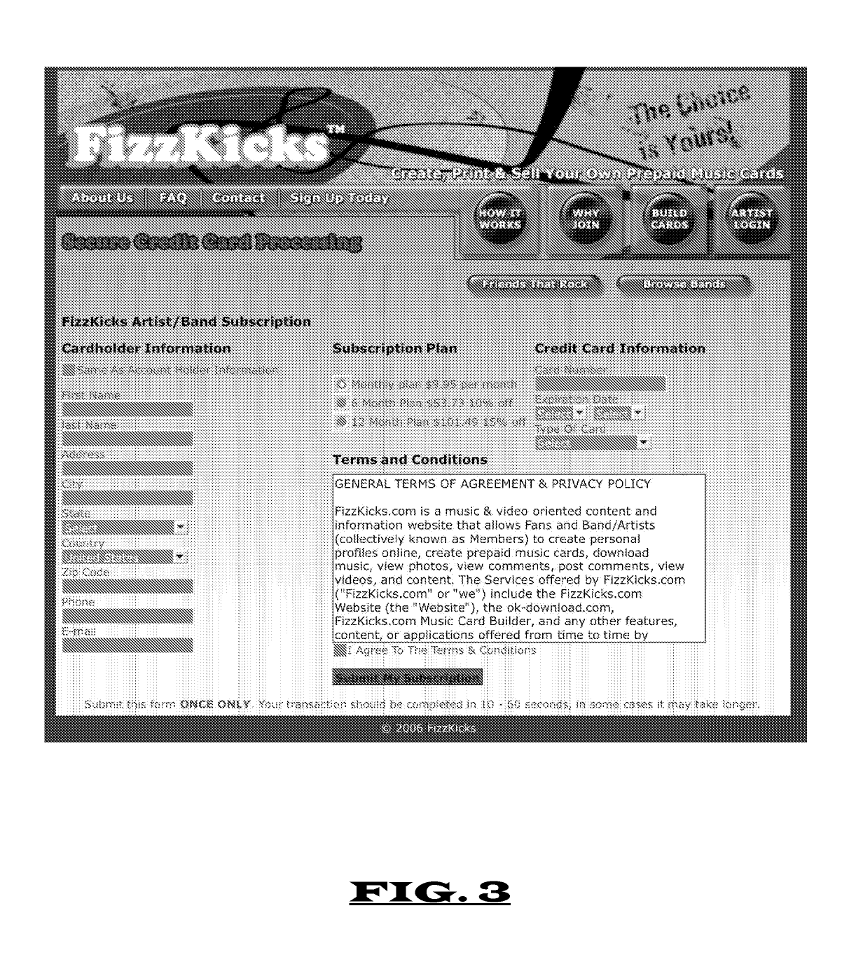

FIG. 4 shows a acknowledgement/login page of embodiments.

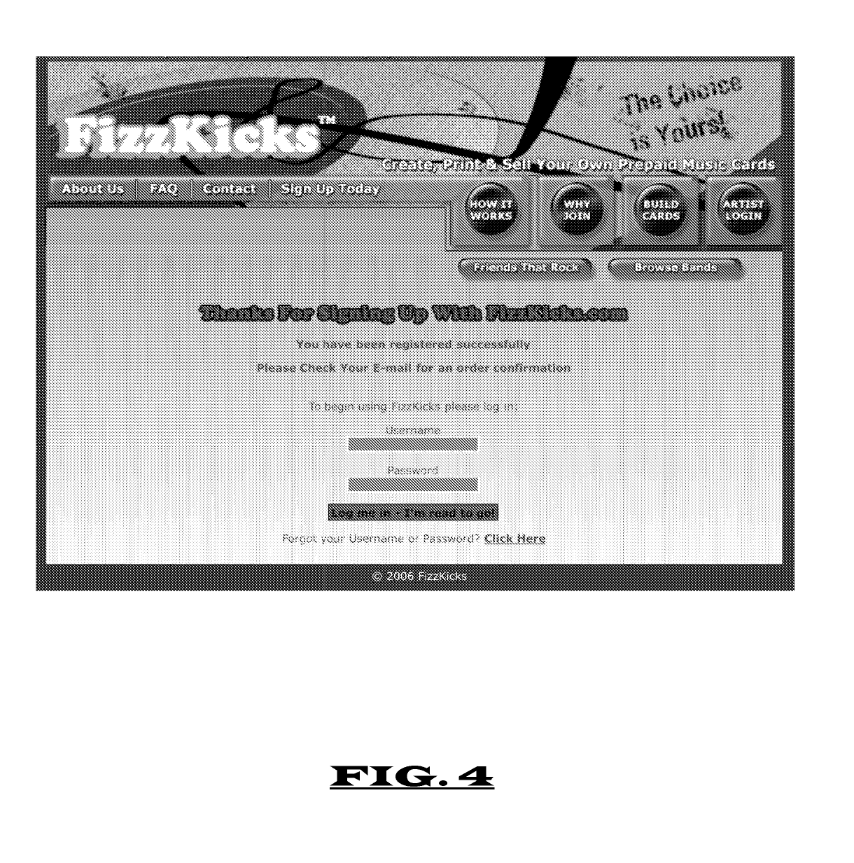

FIG. 5 shows a account management page of embodiments.

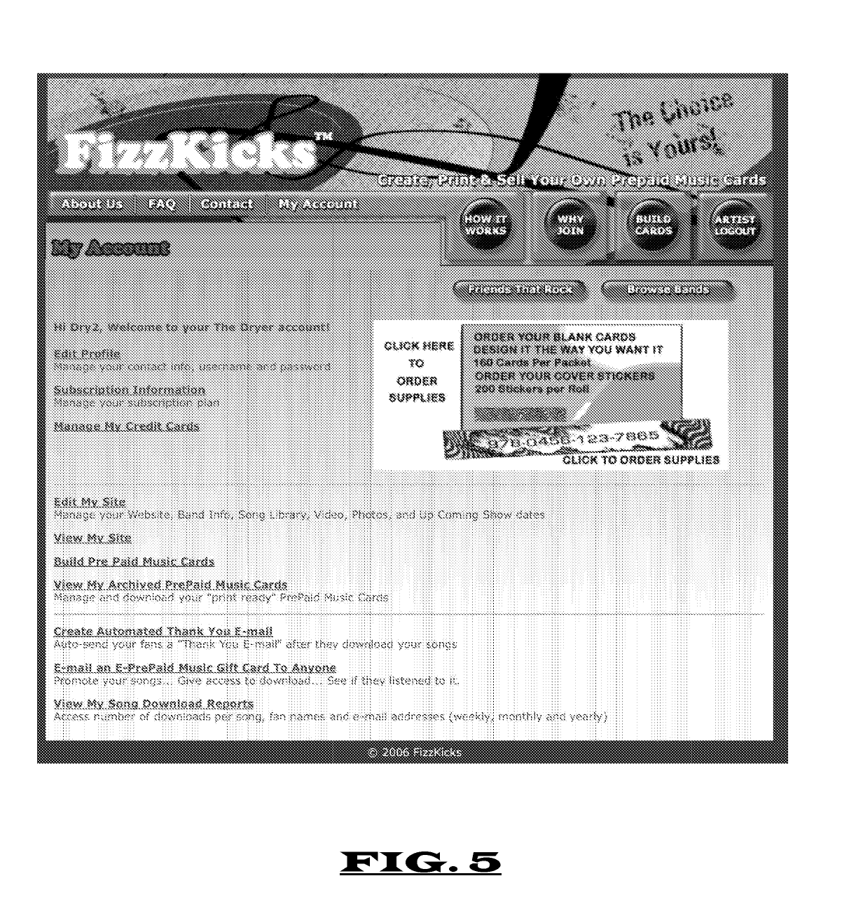

FIG. 6 shows a content management page of embodiments.

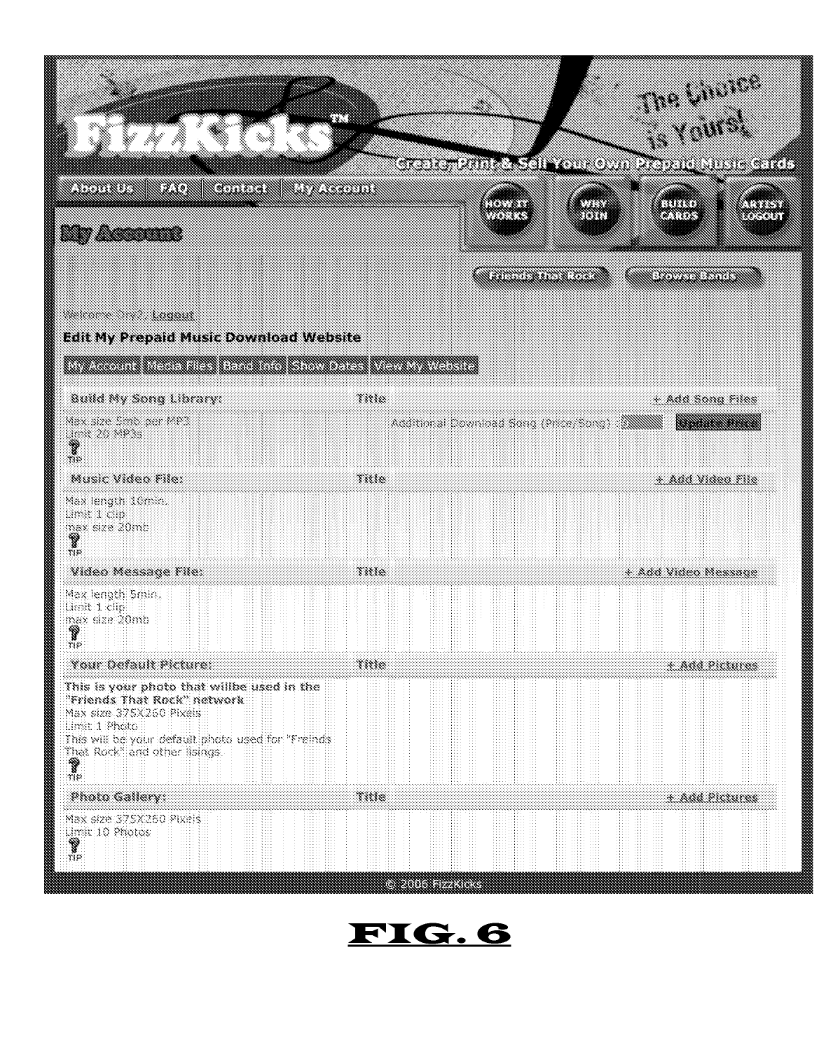

FIG. 7 shows a subscriber information page of embodiments.

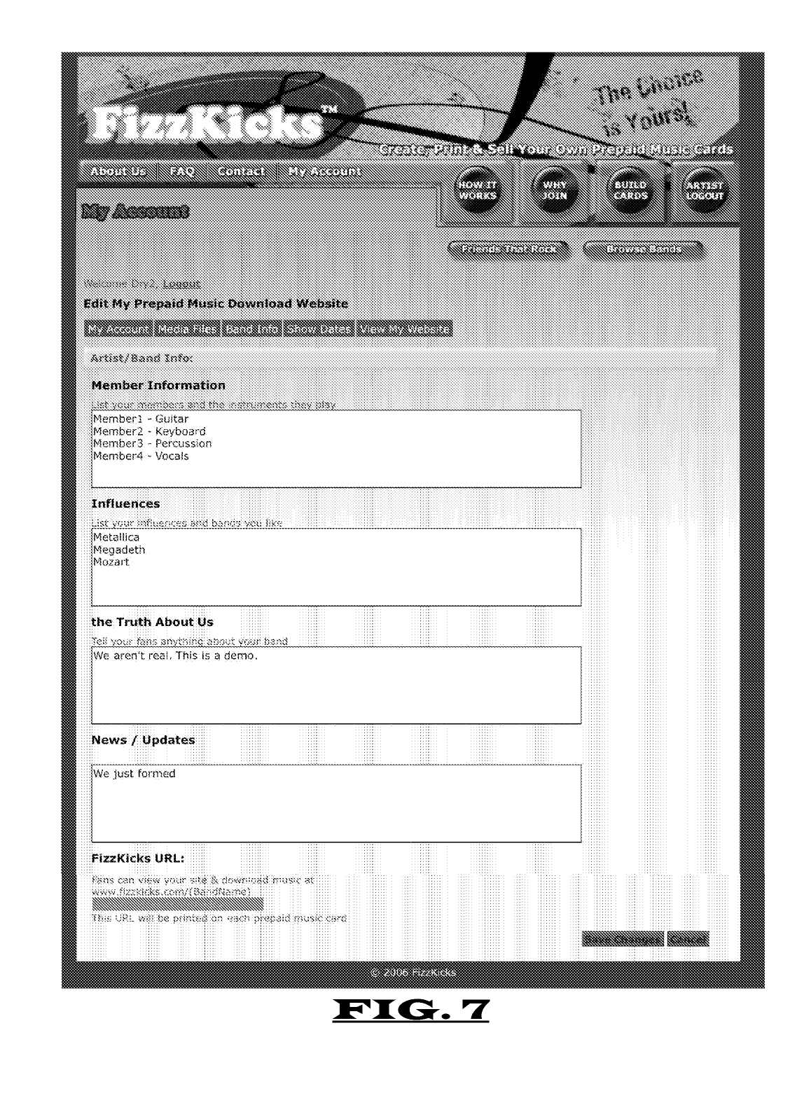

FIG. 8 shows an event management page of embodiments.

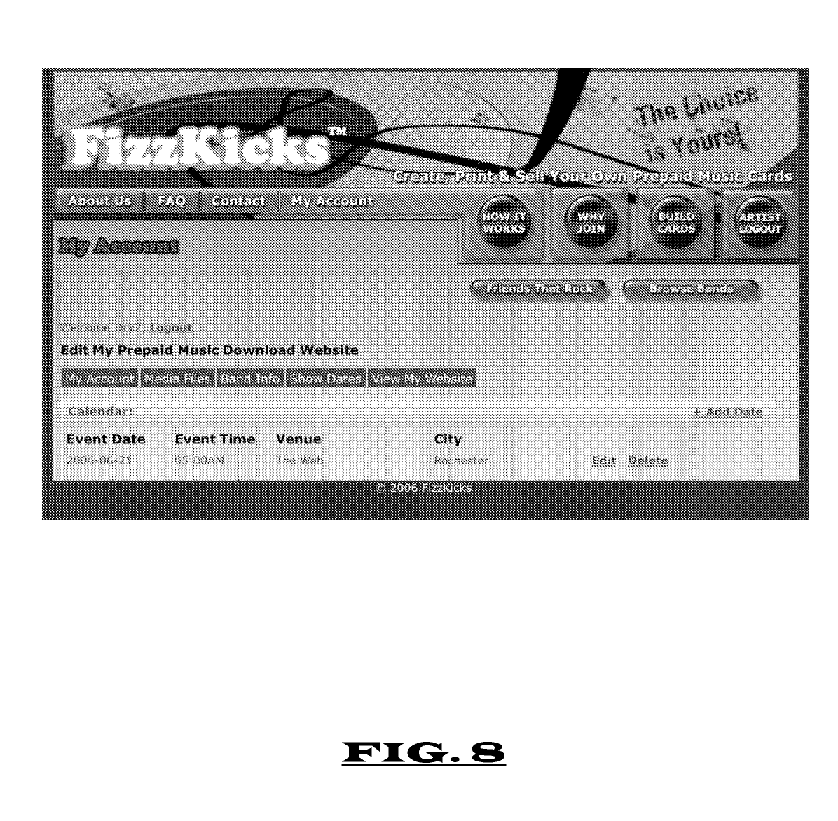

FIG. 9 shows an add event box of embodiments.

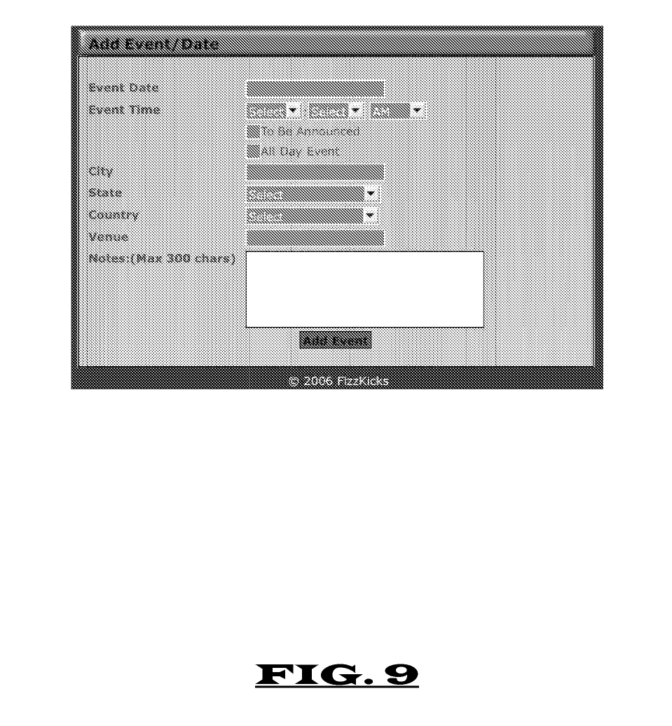

FIG. 10 shows a subsite of embodiments.

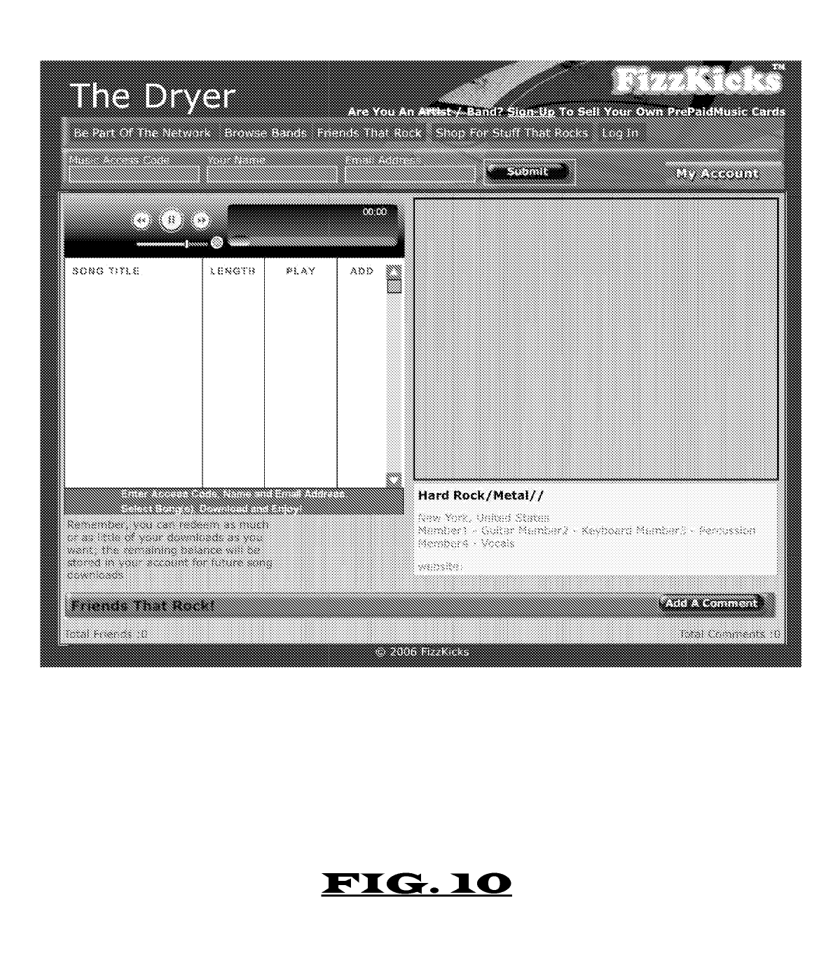

FIG. 11 shows a card creation page of an implementation of embodiments.

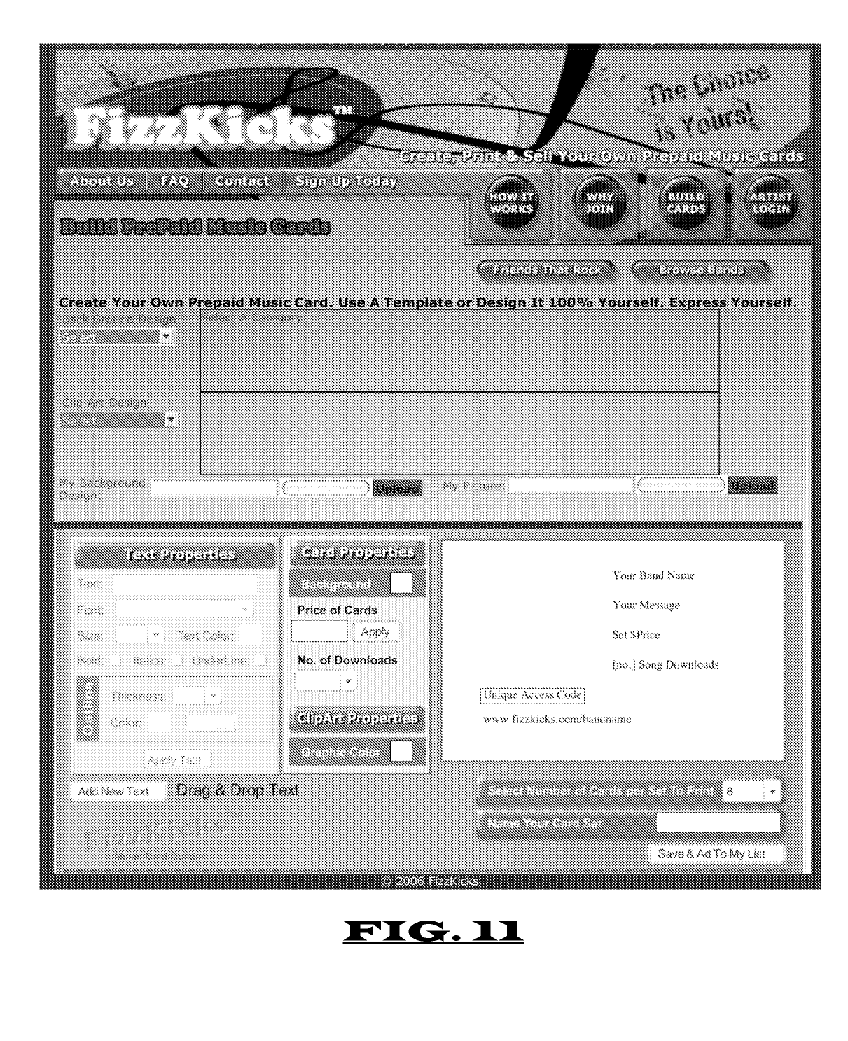

FIG. 12 shows a card creation page of can implementation of embodiments and displaying selections of objects for inclusion on a card design.

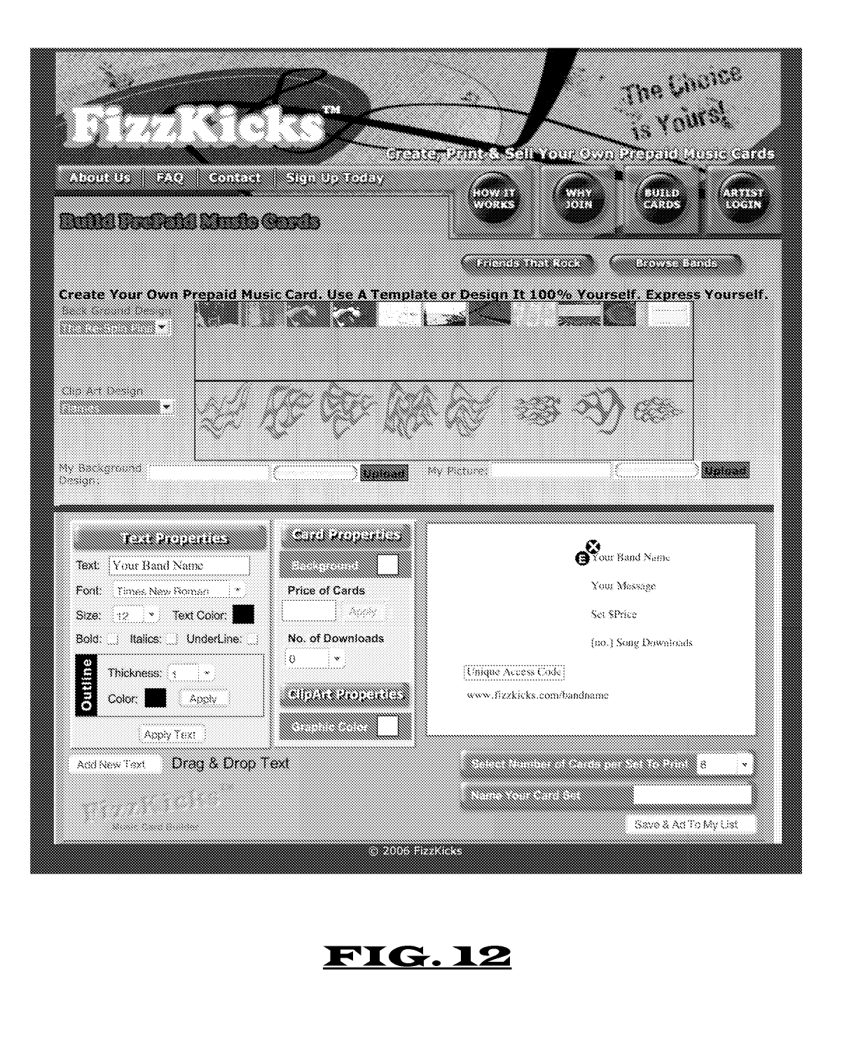

### DESCRIPTION

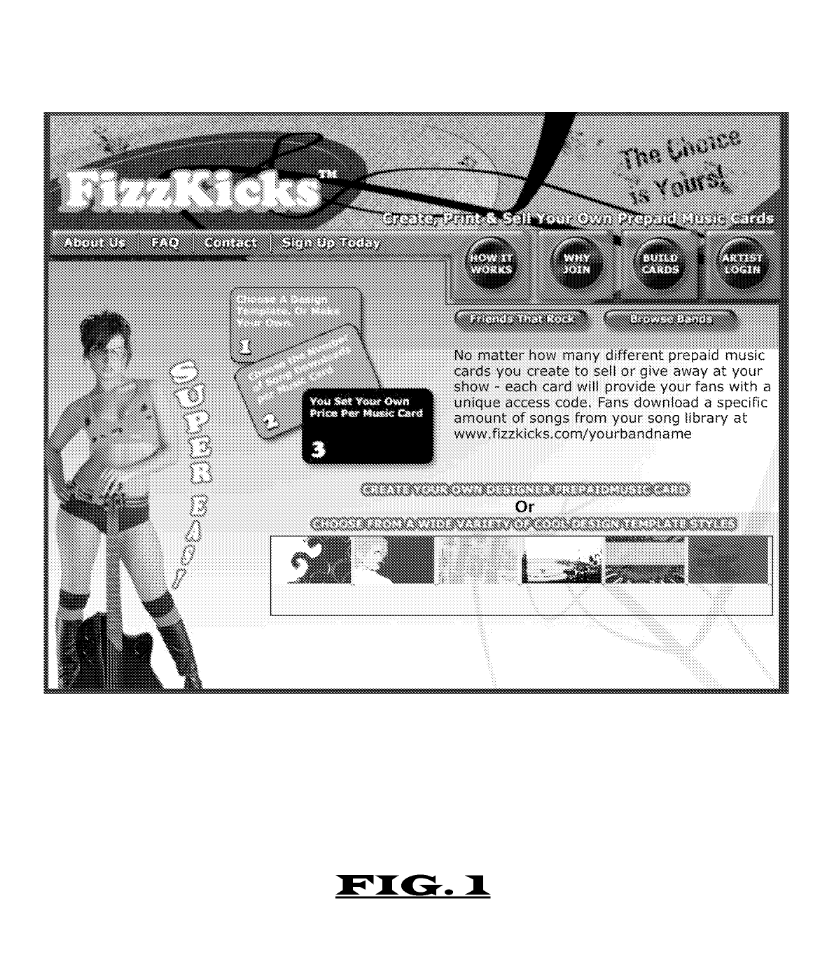

As seem in FIG. 1, the method of embodiments is an electronic content promotion and distribution method comprising offering subscriptions to content creators, allowing content creators to upload content, providing a stored value card creation arrangement, allowing subscribers to create stored value cards with unique respective access codes, and providing a portal through which stored value card holders can redeem the stored value cards for content. Offering subscriptions comprises maintaining a website, allowing content creators to create a username, and providing a subsite for the username. Offering subscriptions can be performed free of charge or can be fee based. In some embodiments, offering subscriptions is performed according to a graduated fee structure in which more services are offered for higher fees.

Allowing subscribers to upload content comprises providing a storage facility, allocating an amount of storage space to each subscriber, providing a user interface with an upload facility with which the subscribed content creator can transmit content to the storage facility, and storing the transmitted content. Allowing content creators to upload content can further comprise allowing customization of content identifying information and allowing association of graphics with the content. Also, allowing subscribers to create stored value cards can comprise providing templates for which a selection of ready-to-use graphics and text formats can be provided, and for which a subscriber can upload custom graphics in embodiments.

Embodiments are particularly suited to implementation via a computer software application, preferably a web based application accessible over a computer network, such as the internet, via a web browser. The application can be hosted on a server connected to the internet and to storage devices on which subscriber content is stored. The application presents a computer user with an initial page including links with which the user can log in if already subscribed, can sign up if not already subscribed and interested in doing so, and/or can learn about the application and the method it executes. The log in link takes the user to a page that requests the subscriber user id and password and presents the user with a submit button or the like. Clicking the submit button takes the subscriber to his or her personalized subsite. Clicking the sign up link on the initial page leads the user through a series of text entry fields that collect relevant information, allowing the user to select a user id and password, and payment information, if appropriate. Once the user is subscribed, he or she is taken to an account page from which the subscriber can personalize and manage and/or view the subscriber's subsite, edit contact and billing information, edit information about the content provider, manage content, and create stored value cards, both physical and virtual.

The account page comprises links to each of the sets of controls, and preferably includes links to order supplies for stored value card printing and assembly. A link to a profile page takes the user to a page very similar to the signup page, in embodiments, and allows the user to alter information such as contact information and the like, as well as basic information about the content and the content provider. Another link can be provided to a subscription management page where the user can change the subscription plan and/or billing information, though some or all of this could be included on the profile page.

The subsite editing page can default to a category of site management, such as content management, or can be a different landing page with links to the various categories the subscriber can control. All category pages preferably include links to the other category pages, the parent page, and a link that allows viewing the subsite as a visitor would see it, allowing proofreading and layout review. Additionally, all pages preferably include links to the subscriber's main account page, the home page of the site, and support/help pages.

The content management page can allow upload of content, deletion of content, and modification of information associated with content, such as text and graphics. The content can include one or a plurality of content types. For example, a band could be allowed to upload music, music videos, video message files, and/or pictures of the band, members, and/or performances. In embodiments, each content type can have a per file size limit and/or a limit on the total number of files per category. For example, a band might be limited to twenty audio files of five megabytes or less, a single music video of twenty megabytes or less, a single video message file of twenty megabytes and five minutes or less, and ten pictures of 375 by 260 pixels, though any sizes and numbers could be used as desired. Embodiments allow the user to select a default photo or graphic for display on the subscriber's subsite.

On the content provider information page, the subscriber can provide various types of information, for example in predefined text entry fields. The information allowed is preferably predefined according to the type of content provider the subscriber represents. For example, a band could provide information about the band itself, its members and the instruments they play, influences, a miscellaneous entry, and news about the band. Other types of content providers could have similar fields. This page in embodiments would also list the URL for the subscriber's subsite.

The events management page can be a simple list of existing entries including date, title, location, and the like, and links for editing or deleting existing entries and adding new entries. A pop-up calendar can be included to assist in the selection of appropriate dates for events.

In embodiments, the account page, and preferably all pages for subscribers, includes a link to a stored value card creation page. On the card creation page, the subscriber is presented with a selection of card background graphics and foreground images from which he/she can choose to include on a card or cards. Preferably, a list of categories of background graphics is presented in a menu, such as a pull-down menu, and the subscriber can select a category of background graphics to view in a background graphics viewing area of the page. The background graphics viewing area preferably presents scaled background graphics available in a category for the subscribers perusal. The user can select a background graphic by clicking the scaled version of a background graphic. As with the background graphics, a list of categories of foreground images is preferably presented in a menu, such as a pull-down menu, and the subscriber can select a category of foreground images to view in a foreground images viewing area of the page. The foreground images viewing area preferably presents scaled foreground images available in a category for the subscribers perusal. The user can select a foreground image by clicking its scaled version.

The card creation page of embodiments includes an interactive card preview in which the selected background graphic and/or foreground image are displayed, can be moved, and can be resized. Additionally, the card preview preferably includes text fields editable by the subscriber, including changing fonts, font colors, and font sizes. To accomplish this, embodiments include a card preview that is in fact an application, such as a Java or Flash based application, allowing such editing of the various card elements. Embodiments further allow subscribers to save stored value card designs that they have created. and can designate a number of cards to be printed at a given time, at which point the system assigns access codes to the cards and creates a printable image of each card to be printed. Preferably, the printable image is a PDF file that the subscriber can download with his or her browser and print from the computer to which the file is downloaded.

In the embodiment shown in the FIGS., the card creation page includes pulldown menus for background graphics and foreground images, with viewers adjacent the pulldown menus in which thumbnails of the graphics are displayed side by side. A card preview area includes some default text objects, such as band name, cost, number of downloads, and the field in which the access code will appear. Clicking a thumbnail selects a graphic and displays it in the card preview. Foreground images can be resized, rotated, and moved about the card. All objects on the card preview show what can be done with them with a mouseover. For example, if the subscriber puts the mouse pointer over the band name, a frame appears around the object with buttons for editing and deletion. When the edit button for a text object is clicked, the subscriber can change the text properties and content with, for example, a text properties area with controls for such properties and content. Additionally, the page can include image manipulation tools for the foreground images, and can include settings for number of cards to be included in a run, cost of each card, and number of downloads each card represents. A “Save and Add to List” button or the equivalent is provided so that the user can save a created card for later access. Once subscribers have printed cards, preferably on stock provided by/purchased from the system, stickers coated with a “scratch-off” coating or the like can be applied to conceal the access code until a recipient is ready to redeem the card for downloading content.

Embodiments include a card management page from which subscribers can view saved stored value cards for easy access when more need to be printed. For example, the card management page can present a list of stored cards with links allowing editing, deletion, preview, and/or download/print of each card. Embodiments further allow various electronic promotions, such as sending automatic customizable thank you e-mail messages, and sending e-mail messages that are the equivalent of a stored value card. For the automated thank you notes, embodiments allow subscribers to set a subject header and message body that will be used for the automated e-mail messages. For the e-mail stored value card equivalents, the subscribers can create simple text based messages, HTML-based messages, a message with a link to a redemption page, can send a single printable image as an attachment, or a combination of two or more of these options.

Embodiments further provide a reports page from which subscribers can access statistics for their accounts. Preferably, the reports made available to subscribers include at least the number of downloads per file, the names and e-mail addresses of the downloaders, and can include this information over various periods.

Thus, embodiments comprise a web site to which content creators can subscribe to create or have created prepaid stored value card designs that can be downloaded and printed locally on stock purchased from the web site. Each card has a unique access code that the system uses to identify the card and a monetary value or a number of files for which it can be redeemed (monetary value only for file purchase). Once the cards are printed, the subscribers can distribute them, either free or for a fee, or can sell them in lieu of inventory of the content. For example, bands can create cards for downloads of a small number of songs and give them away to promote themselves, or could create cards for the equivalent of a CD in downloads and sell the cards instead of CDs.

Card holders visit a site identified on the card to redeem the card and download content. Additionally, if a subscriber has opted to allow such, card holders may purchase additional content from the site. To use the card, the holder scratches off the coating covering the access code(s), if used, enters the access code, and downloads the content. The code in embodiments is entered after selection of content for download, such as in a “checkout” page, but could instead be entered before content is selected for download.

Embodiments charge subscribers a fee for the service, the fee being monthly but discounts preferably being offered for prepayment of longer periods. Where subscribers allow purchase of content from their subsites, the subscribers in embodiments receive all funds derived from the purchase.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An electronic content promotion and distribution method comprising offering subscriptions to content creators, allowing content creators to upload content, providing a stored value card creation arrangement, allowing subscribers to create stored value cards with unique respective access codes, and providing a portal through which stored value card holders can redeem the stored value cards for content.

2. The method of claim 1 wherein offering subscriptions comprises maintaining a website, allowing content creators to create a username, and providing a subsite for the username.

3. The method of claim 1 wherein allowing subscribers to upload content comprises providing a storage facility, allocating an amount of storage space to each subscriber, providing a user interface with an upload facility with which the subscribed content creator can transmit content to the storage facility, and storing the transmitted content.

4. The method of claim 3 wherein allowing content creators to upload content comprises allowing customization of content identifying information and allowing association of graphics with the content.

5. The method of claim 1 wherein allowing subscribers to create stored value cards comprises providing templates.

6. The method of claim 5 wherein providing templates comprises providing a selection of objects for inclusion on the stored value cards.

7. The method of claim 5 wherein providing a selection of objects includes providing a selection of background graphics for the stored value cards.

8. The method of claim 5 wherein providing a selection of objects includes providing a selection of foreground images.

9. The method of claim 5 wherein providing a selection of objects includes providing editable text fields.

10. The method of claim 1 wherein allowing subscribers to created stored value cards comprises providing a graphic upload facility.
